(19) United States
(12) Patent Application Publication
(10) Pub. No.: US 2017/0066043 A1
(43) Pub. Date: Mar. 9, 2017

(54) METHOD FOR SETTING UP A HANDHELD RIVETER

(71) Applicant: VVG-BEFESTIGUNGSTECHNIK GMBH & CO., Neumuenster (DE)

(72) Inventor: MICHAEL H. HONSEL, Esgrus (DE)

(73) Assignee: VVG-BEFESTIGUNGSTECHNIK GMBH & CO., Neumuenster (DE)

(21) Appl. No.: 15/256,747

(22) Filed: Sep. 6, 2016

(30) Foreign Application Priority Data
Sep. 8, 2015 (DE) 10 2015 115 057.3

(51) Int. Cl. B21J 15/26; B21J 15/02; B21J 15/10; G01L 1/04

(52) U.S. Cl. CPC B21J 15/26; G01L 1/04; B21J 15/02; B21J 15/105

(57) ABSTRACT

A method for setting up a riveter comprising an electrical drive which is configured to place a blind riveting element in a location hole. The riveter applies a tensile force to a tensile element of the blind riveting element during a rivet placement process so that the tensile element tears away from a remainder of the blind riveting element at a predetermined breaking point at an end of the placement process. The tensile force used to place the blind riveting element is defined by an adjustable maximum value which is determined during the setting up. The method includes performing the placement process with the blind riveting element of the type to be used, acquiring a progression of the tensile force during the placement process, determining at least one characteristic value from the progression, and fixing the adjustable maximum value as a function comprising the at least one characteristic value.

### CROSS REFERENCE TO PRIOR APPLICATIONS

Priority is claimed to German Patent Application No. DE 10 2015 115 057.3, filed Sep. 8, 2015. The entire disclosure of said application is incorporated by reference herein.

### FIELD

The present invention relates to a method for setting up a handheld riveter which is in particular provided with an electrical drive for placing blind riveting elements in a location hole.

### BACKGROUND

Such riveters are in particular used to place blind riveting nuts and/or blind riveting screws. The method is now used to set up the riveter for a specific type of blind riveting elements which are subsequently to be placed with the riveter in large numbers.

The riveter is here designed to apply a tensile force to a tensile element of the blind riveting element during the placement process. In riveters, the characteristic variable in the rivet placement process is the maximum tensile force that is applied to the blind riveting element. This maximum tensile force in electrically driven riveters is in turn defined by the electrical current consumed by the electrical drive and converted into tensile force. The maximum tensile force, and hence also the maximum consumed amperage, must here be defined so that the riveting element is sufficiently attached while, at the same time, the applied force is not so high to destroy the riveting element in the placement process. The maximum current consumption of the drive in electrically operated riveters must thus be limited by prescribing a maximum amperage value.

Riveters have to date been set up via a cumbersome procedure where several riveting processes are performed with a specific type, and the suitable maximum force is correspondingly adjusted, for example, in trials. Tables are alternatively provided from which preferred setting parameters are derived, wherein the user selects a suitable value from the table and then correspondingly manually sets the riveter.

### SUMMARY

An aspect of the present invention is to provide a simplified method to set up a handheld riveter of the kind described above.

In an embodiment, the present invention provides a method for setting up a handheld riveter comprising an electrical drive which is configured to place a blind riveting element in a location hole for a type of blind riveting elements to be used. The handheld riveter is configured to apply a tensile force to a tensile element of the blind riveting element during a rivet placement process so that the tensile element tears away from a remainder of the blind riveting element at a predetermined breaking point at an end of the placement process. The tensile force used to place the blind riveting element is defined by an adjustable maximum value (Iₘₐₓ) which is determined during the setting up. The method includes performing the placement process with the blind riveting element of the type to be used, acquiring a progression of the tensile force (F) during the placement process, determining at least one characteristic value (I_{A}) from the progression, and fixing the adjustable maximum value (Iₘₐₓ) as a function comprising the at least one characteristic value (I_{A}).

### BRIEF DESCRIPTION OF THE DRAWINGS

The present invention is described in greater detail below on the basis of embodiments and of the drawings in which:

FIG. 1 shows the progression of amperage over the tensile distance while placing a blind riveting element outside of a location hole;

FIG. 2 shows various progressions of amperage over the tensile distance while placing a blind riveting element in a location hole with different sized clamping areas; and

FIG. 3 shows a progression of amperage over the tensile distance while setting up the riveter according to the present invention, with a recorded, fixed amperage maximum value.

### DETAILED DESCRIPTION

In an embodiment, the present invention provides a method to set up a handheld riveter, which is in particular provided with an electrical drive, to place blind riveting elements in a location hole on a type of blind riveting elements to be used. Blind riveting nuts and/or blind riveting screws are in particular used. The riveter is designed to apply a tensile force to a tensile element of the blind riveting element during the placement process, with the tensile element in particular tearing away from the remainder of the blind riveting element at a predetermined breaking point at the end of the placement process. The tensile force used to place a blind riveting element is defined by an adjustable maximum value, which is fixed during setup.

The method comprises the following procedural steps:
executing a placement process with the blind riveting element of the type to be used;
acquiring a progression of the tensile force during the placement process;
determining at least one characteristic value from this progression; and
fixing the maximum value as a function of the characteristic value.

The core of the present invention in particular lies in the fact that the riveter is used to execute a placement process with corresponding riveting elements, and that the progression of the tensile force is acquired in the placement process. At least one characteristic value is determined from the progression of the tensile force based upon which the maximum value to be set is fixed. Provided for this purpose is a function which is used to calculate the maximum value to be set from the characteristic value.

The tensile force need not explicitly be measured in order to acquire the progression of tensile force, it is sufficient to acquire the progression of a physical value that is directly correlated with the tensile force, in particular the current consumption of the electrical drive. The current consumed by the drive is largely directly proportional to the generated tensile force. As a consequence, the measured values for the amperage can be used to reconstruct or to calculate the progression of tensile force. The amperage can, for example, be measured using a multimeter etc. In an embodiment, the progression of the tensile force can, for example, be acquired directly via a force sensor, in particular, a strain gauge. The force sensor can be secured to a drawbar of the riveter. The maximum value can involve a tensile force maximum value. The maximum value can also be an amperage maximum value which is used to operate a current limiter of the drive, thereby preventing the tensile force from becoming too great.

The advantage to the method of the present invention lies in the fact that parameters required for setting the riveter can be derived from the one, initial rivet placement process itself. Only the progression of the current consumption therefore need be observed. For example, the characteristic value can be ascertained just from the latter, and the maximum value can in turn be determined therefrom. The method of the present invention is therefore robust and insusceptible to errors since it largely avoids any intellectual activity of the user.

The plastic properties of the corresponding blind riveting element here have an especially powerful impact on the progression of tensile force over the tensile distance if the blind riveting element is not arranged in a location hole corresponding to the blind riveting element in the rivet placement process during setup, but is rather situated outside of this location hole during setup. This also encompasses any and all alternatives in which the blind riveting element is arranged in a location hole which is clearly too large, which consequently is not a location hole that corresponds to the blind riveting element in the sense of the present application.

The aforementioned arrangement in particular makes it possible to recognize a first maximum in the progression of tensile force at which a first strong deformation of the closing bead has taken place, after which no more significant deformation occurs as the tensile length is further elevated. The deformation that later must be applied to fasten the riveting element in the location hole essentially also takes place in this first maximum.

The value of the first maximum can then be multiplied by a preset value, in particular by a factor of between 1.1 and 1.3. The maximum value can then be fixed from this multiplication step taking into account a user input if necessary.

In an embodiment of the present invention, the function for fixing the maximum value can further, for example, consider a user input. Parameters that cannot be reflected by the pure rivet placement process as described above can here be taken into account, for example, particulars involving special material pairings or requirements on greater safety, and hence a possibly larger required tensile force.

In an embodiment of the present invention, the control unit can, for example, be used to ascertain the characteristic value from the current consumption during a placement process. The control unit here encompasses an amperage measuring unit which records the amperage consumed by the drive unit in the placement process from which the progression of tensile force can then be acquired. The amperage maximum value can then be fixed as the force maximum value.

In an embodiment of the present invention, the ascertained maximum value can, for example, be shown to the user via a display located on the riveter. This provides the user with additional control options, for example, by comparing the displayed maximum value with a manufacturer specification for the type of blind riveting element.

The present invention further relates to a handheld riveter which is set up to implement the above method. The riveter includes a device to acquire the progression of tensile force during a rivet placement process, and a control unit to analyze the acquired progression and to fix the maximum value based on a characteristic point defined in the progression of tensile force.

This yields the advantages already mentioned in relation to the method along with other potential embodiments.

In an embodiment of the present invention, the riveter of the aforementioned type can, for example, encompass input elements, in particular entry keys, for entering a user input. Such a user input can be used to enter additional parameters to be considered by the function to fix the maximum value. A display which shows the valid maximum value can alternatively or in combination be provided therewith.

The present invention will be explained in more detail below based on the drawings.

In an electrically operated riveter according to the present invention, the tensile force applied to a tensile element of the blind riveting element is defined by the amperage. This amperage is consumed by an electric drive while generating the tensile force. A riveter suitable for this purpose is described, for example, in DE 10 2013 105 703 A1.

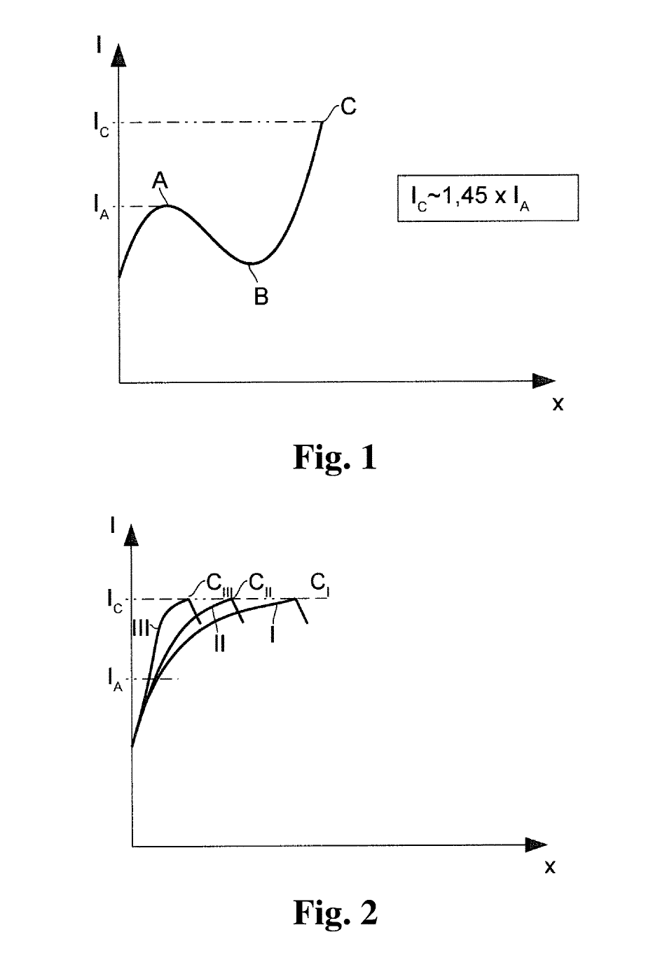

FIG. 1 shows the progression of amperage I over the tensile distance x of a drawing mandrel of the riveter during a placement process. In this placement process, the riveting element is not accommodated in a location hole, but is rather freely held in the air by the riveter. The tensile force, and hence the amperage I, initially rises sharply, and reaches a first maximum at point A. This first maximum A arises from a closing bead of the blind riveting element initially being reshaped. After this first reshaping, the force diminishes as exposure to tensile stress continues until reaching a minimum B. The blind rivet subsequently abuts against a stop of the riveter, so that the force now again sharply rises until reaching a second maximum C, at which the blind riveting element is destroyed.

Two marked variables for rivet placement can consequently be derived from FIG. 1. One is the amperage I_{A} required to apply the force to generate the closing bead. The other is the current amperage I_{C} at which the blind riveting element is destroyed.

FIG. 2 shows the progression of amperage over the progression of the tensile distance x for a rivet placement process in which the blind riveting element is situated as intended in a location hole corresponding to the blind riveting element. The progression is here shown for different sized clamping areas. Viewed in an axial direction of the rivet, the clamping area here represents the length of the location hole over which the clamping between the riveting element and location hole takes place. Curve I here describes the progression for a clamping area of 1 mm, curve II describes the progression for a clamping area of 2 mm, and curve III describes the progression for a clamping area of 3 mm.

The destruction of the blind riveting element is here independent of the extent of the clamping area at the same respective force at maximum C, i.e., given the appearance of amperage I_{C}. Only the tensile distance traversed by that point diminishes the larger the clamping area becomes.

The maximum amperage must therefore be set between these two values.

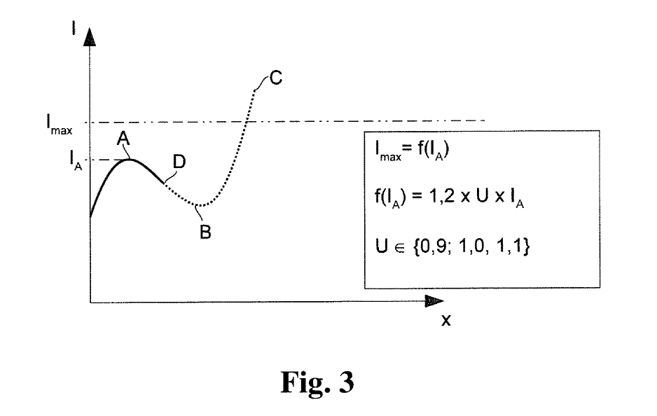

In the setup process according to the present invention, a rivet placement process is now performed according to FIG. 3 in which the blind riveting element is situated outside of the location hole, i.e., is held freely in the air by the riveter. The curve now rises sharply up to a first maximum A, which the riveter assumes to be amperage I_{A} as the characteristic value. The placement process can be terminated at D on the way toward the first minimum B since it is only important that the amperage value be determined at the first maximum A.

The amperage maximum value Iₘₐₓ is now calculated from the acquired amperage value I_{A} as a function of I_{A}. For example, the function exhibits a constant, in this case 1.2, along with a user input value U, which are both multiplied by the recorded amperage value I_{A} at the first maximum A. For example, the user input value U can be set via a touch-sensitive display or a switch position directly on the riveter, and can contain the values 0.9, 1.0 or 1.1. As a consequence, the amperage maximum value is set to 1.2 times the amperage at the first maximum A given a user input value U of 1.0. The ability of the user to make an entry gives the user the option of prescribing deviations. For example, specific types of blind riveting elements are only destroyed at a distinctly higher amperage I_{C} that more than doubles the amperage I_{A} at the first maximum A. In such blind riveting elements, the amperage maximum value could be increased relative to the amperage value I_{A} at the first maximum A by setting the user input value to a value>1.0.

The amperage maximum value Iₘₐₓ is now clearly above the amperage value I_{A} at the first maximum A so that the closing bead of the riveting element is smoothly generated. At the same time, the amperage maximum value Iₘₐₓ is distinctly below the maximum at C where the riveting element would fail.

The present invention is not limited to embodiments described herein; reference should be had to the appended claims.

What is claimed is:

1. A method for setting up a handheld riveter comprising an electrical drive which is configured to place a blind riveting element in a location hole for a type of blind riveting elements to be used,
the handheld riveter being configured to apply a tensile force to a tensile element of the blind riveting element during a rivet placement process so that the tensile element tears away from a remainder of the blind riveting element at a predetermined breaking point at an end of the placement process,
the tensile force used to place the blind riveting element being defined by an adjustable maximum value which is determined during the setting up,
the method comprising:
performing the placement process with the blind riveting element of the type to be used;
acquiring a progression of the tensile force during the placement process;
determining at least one characteristic value from the progression; and
fixing the adjustable maximum value as a function comprising the at least one characteristic value.

2. The method as recited in claim 1, wherein the blind riveting element is arranged outside of the location hole when setting up the handheld riveter.

3. The method as recited in claim 2, wherein the method further comprises:
ascertaining a first maximum of the progression as the at least one characteristic value.

4. The method as recited in claim 4, wherein the fixing of the adjustable maximum value occurs by multiplying a value of the first maximum by a prescribed factor.

5. The method as recited in claim 4, wherein the prescribed factor is between 1.1 and 1.5.

6. The method as recited in claim 1, wherein the function for fixing the adjustable maximum value further comprises a user input.

7. The method as recited in claim 1, wherein a control unit is used to determine an amperage maximum value as the adjustable maximum value from a current consumption of the electrical drive during the placement process.

8. The method as recited in claim 7, further comprising:
displaying the amperage maximum value determined to a user via a display arranged on the handheld riveter.

9. The method as recited in claim 1, wherein,
the acquiring of the progression of the tensile force during the placement process is based on a current consumption of the electric drive of the handheld riveter or of a force sensor.

10. A handheld riveter set up to implement the method as recited in claim 1, the handheld riveter comprising:
a device configured to acquire the progression of the tensile force during a rivet placement process; and
a control unit configured to analyze the acquired progression and to fix the adjustable maximum value based on a characteristic point defined in the progression.

11. The handheld riveter as recited in claim 10, further comprising:
entry keys configured so that a user of the handheld riveter can enter a user input value into the handheld riveter.

12. The handheld riveter as recited in claim 10, wherein the user input value (U) fixes the adjustable maximum value.

13. The handheld riveter as recited in claim 10, further comprising:
a display configured to display the adjustable maximum value fixed by the control unit.
